(19) United States
(12) Patent Application Publication
(10) Pub. No.: US 2018/0071943 A1
(43) Pub. Date: Mar. 15, 2018

(54) CUTTING CHAIN FOR A CHAINSAW

(71) Applicant: HUSQVARNA AB, HUSKVARNA (SE)

(72) Inventors: Hasse Lilja, Jönköping (SE); Niklas Sarius, Jönköping (SE); Hans-Åke Sundberg, Bankeryd (SE); Johan Millenberg, Bankeryd (SE); Jonatan Gunér, Huskvarna (SE); Adam Ståhlkrantz, Huskvarna (SE); Per Carlbäck, Gränna (SE); Richard Hall, Taberg (SE)

(21) Appl. No.: 15/554,726

(22) PCT Filed: Mar. 2, 2016
(86) PCT No.: PCT/IB2016/051190

§ 371 Date: Aug. 31, 2017

Related U.S. Application Data
(60) Provisional application No. 62/128,176, filed on Mar. 4, 2015.

(51) Int. Cl. B27B 33/14

(52) U.S. Cl. CPC B27B 33/142

(57) ABSTRACT

A cutting chain (300) for a chainsaw (100) may include a plurality of drive links (310) and a plurality of side links (320). The drive links (310) are arranged to lie in a plane parallel to a plane in which a guide bar (120) about which the chain (300) is rotatable lies. The side links (320) are operably coupled to respective ones of the drive links (310) and are oriented to lie in respective planes substantially parallel to the plane. At least some of the side links (320) include cutting portions. The drive links (310) and side links (320) are attached to each other by rivets (360), and the rivets (360) have a longitudinal length that is less than or equal to a width of the side links (320) in a transverse direction.

### CROSS REFERENCE TO RELATED APPLICATION

This application claims priority to U.S. provisional application No. 62/128,176 filed on Mar. 4, 2015, the entire contents of which are incorporated herein by reference.

### TECHNICAL FIELD

Example embodiments generally relate to hand held power equipment and, more particularly, relate to cutting chain improvements for a chainsaw.

### BACKGROUND

Chainsaws are commonly used in both commercial and private settings to cut timber or perform other rigorous cutting operations. Because chainsaws are typically employed in outdoor environments, and the work they are employed to perform often inherently generates debris, chainsaws are typically relatively robust hand held machines. They can be powered by gasoline engines or electric motors (e.g., via batteries or wired connections) to turn a chain around a guide bar at relatively high speeds. The chain includes cutting teeth that engage lumber or another medium in order to cut the medium as the teeth are passed over a surface of the medium at high speed.

Chainsaws are somewhat notorious for providing a cutting path that can be relatively large as compared to cutting performed by a blade. The cuts performed by a blade tend to be smaller because the blade is thinner than the transverse length of the chain (e.g., the width of the links). Because the chainsaw has a wider cutting path, more wood or other media that is being cut, tends to be removed and lost during the cutting process.

As such, it may be desirable to explore a number of different chain design improvements that could be employed alone or together with other design changes to improve overall chainsaw, and cutting chain, performance.

### BRIEF SUMMARY OF SOME EXAMPLES

Some example embodiments may provide for a chainsaw chain constructed with a modification to cutter links to improve cutting properties. The modification to the cutter links of the chain may improve cutting properties to make the chain cut more like a blade than a typical chain. The modification, which involves designing a thin chain, may make the chain have cutting properties that include the removal of less material during cutting. Other improvements may also be possible, and the improvements can be made completely independent of each other, or in combination with each other in any desirable configuration. Accordingly, the operability and utility of the chainsaw may be enhanced or otherwise facilitated.

In an example embodiment, a cutting chain for a chainsaw is provided. The cutting chain may include a plurality of drive links and a plurality of side links. The drive links are arranged to lie in a plane parallel to a plane in which a guide bar about which the chain is rotatable lies. The side links are operably coupled to respective ones of the drive links and are oriented to lie in respective planes substantially parallel to the plane. At least some of the side links include cutting portions. The drive links and side links are attached to each other by rivets, and the rivets have a longitudinal length that is less than or equal to a width of the side links in a transverse direction.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a chainsaw according to an example embodiment;

FIG. 2 illustrates a side view of a chainsaw guide bar employing a chain;

FIG. 3 illustrates a perspective side view of a chain design in accordance with an example embodiment;

FIG. 4 illustrates a front view of the chain of FIG. 3 in accordance with an example embodiment; and

FIG. 5 illustrates a top view of the chain of FIG. 3 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

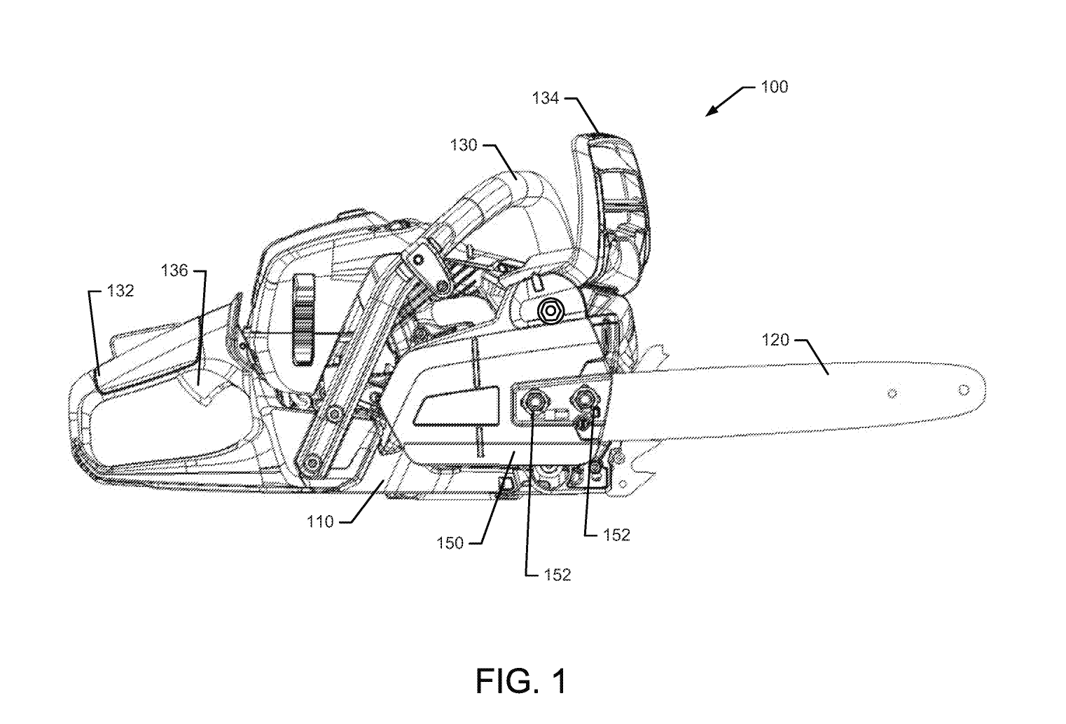

FIG. 1 illustrates side view of a chainsaw 100 according to an example embodiment. As shown in FIG. 1, the chainsaw 100 may include a housing 110 inside which a power unit or motor (not shown) is housed. In some embodiments, the power unit may be either an electric motor or an internal combustion engine. Furthermore, in some embodiments, the power unit may include more than one electric motor where one such electric motor powers the working assembly of the chainsaw 100 and the other electric motor of the power unit powers a pump that lubricates the working assembly or provides momentum for moving other working fluids within the chainsaw 100. The chainsaw 100 may further include a guide bar 120 that is attached to the housing 110 along one side thereof. A chain (not shown) may be driven around the guide bar 120 responsive to operation of the power unit in order to enable the chainsaw 100 to cut lumber or other materials. The guide bar 120 and the chain may form the working assembly of the chainsaw 100. As such, the power unit may be operably coupled to the working assembly to turn the chain around the guide bar 120.

The chainsaw 100 may include a front handle 130 and a rear handle 132. A chain brake and front hand guard 134 may be positioned forward of the front handle 130 to stop the movement of the chain 122 in the event of a kickback. In an example embodiment, the hand guard 134 may be tripped by rotating forward in response to contact with a portion of the arm (e.g., the hand/wrist) of the operator of the chainsaw 100. In some cases, the hand guard 134 may also be tripped in response to detection of inertial measurements indicative of a kickback.

The rear handle 132 may include a trigger 136 to facilitate operation of the power unit when the trigger 136 is actuated. In this regard, for example, when the trigger 136 is actuated (e.g., depressed), the rotating forces generated by the power unit may be coupled to the chain either directly (e.g., for electric motors) or indirectly (e.g., for gasoline engines). The term “trigger,” as used herein, should be understood to represent any actuator that is capable of being operated by a hand or finger of the user. Thus, the trigger 136 may represent a button, switch, or other such component that can be actuated by a hand or portion thereof.

Some power units may employ a clutch to provide operable coupling of the power unit to a sprocket that turns the chain. In some cases (e.g., for a gasoline engine), if the trigger 136 is released, the engine may idle and application of power from the power unit to turn the chain may be stopped. In other cases (e.g., for electric motors), releasing the trigger 136 may secure operation of the power unit. The housing 110 may include a fuel tank for providing fuel to the power unit. The housing 110 may also include or at least partially define an oil reservoir, access to which may be provided to allow the operator to pour oil into the oil reservoir. The oil in the oil reservoir may be used to lubricate the chain as the chain is turned.

As can be appreciated from the description above, actuation of the trigger 136 may initiate movement of the chain around the guide bar 120. A clutch cover 150 may be provided to secure the guide bar 120 to the housing 110 and cover over the clutch and corresponding components that couple the power unit to the chain (e.g., the sprocket and clutch drum). As shown in FIG. 1, the clutch cover 150 may be attached to the body of the chainsaw 100 (e.g., the housing 110) via nuts 152 that may be attached to studs that pass through a portion of the guide bar 120. The guide bar 120 may also be secured with the tightening of the nuts 152, and a tightness of the chain can be adjusted based on movement of the guide bar 120 and subsequent tightening of the nuts 152 when the desired chain tightness is achieved. However, other mechanisms for attachment of the clutch cover 150 and/or the guide bar 120 may be provided in other embodiments including, for example, some tightening mechanisms that may combine to tighten the chain in connection with clamping the guide bar 120.

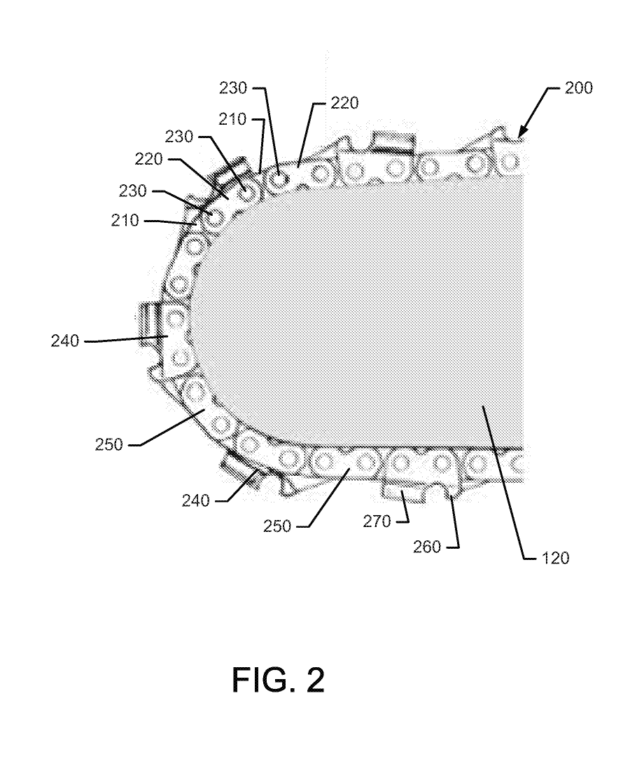

In some embodiments, the guide bar 120 may be formed from two laminate core sheets that lie in parallel planes along side each other to define a channel around a periphery of the guide bar 120. The chain (or at least a portion of the chain) may ride in the channel, as the rest of the chain rides along the periphery of the guide bar 120 to engage media for cutting. FIG. 2 illustrates a typical chain 200 disposed on the guide bar 120. The chain 200 includes a plurality of center drive links 210 that each include a portion thereof that rides in the channel. Each center drive link 210 is attached to an adjacent pair of side links 220 by rivets 230 that extend perpendicular to the longitudinal length of the links. A rivet 230 is provided at the front portion of each center drive link 210 to attach the center drive link 210 to the rear portion of a preceding side links 220 and another rivet 230 is provided at the rear portion of each center drive link 210 to attach the center drive link 210 to the front portion of a subsequent side links 220. As such, each pair of side links 220 connects to opposing sides of the center drive links 210, and the connections are repeated in alternating fashion to complete a circular or endless chain.

For some pairs of side links 220 of the chain 200 one of the side links may be formed as a cutter link 240. Meanwhile, pairs of side links that do not include a cutter link 240 may be referred to as tie links 250. The cutter links 240 may be provided with two portions including a depth gauge portion 260 and a cutting portion 270. The cutting portion 270 may generally engage material that extends beyond the depth of the depth gauge portion 260 when the chain 200 is rotated. Meanwhile, the tie links 250 may not include cutting portions or depth gauge portions and may be provided to simply extend the length of the chain 200 while providing a space between portions of the chain 200 that will create friction during cutting operations. If every side link 210 was a cutter link 240, the friction on the chain 200 would be very high, and it would be difficult to provide sufficient power to turn the chain, and control of the chainsaw 100 could also become difficult. Additionally, if the cutter links 240 were merely allowed to engage large portions of the media to be cut without a restriction on the cutting depth for each cycle, the friction would be high and the run of the chain would be less smooth. Accordingly, the depth gauge portion 260 allows a limit to be placed on the cutting depth or amount of material to be cut with each pass of the cutter link 240.

In a typical chain, such as the one shown in FIG. 2, cutter links 240 are provided alternating on right and left sides of the chain. Moreover, left side cutter links and right side cutter links are generally symmetrical to provide for a smooth cut that makes a cutting path through the media being cut (e.g., wood) that is at least wider than the rivets 230 or, otherwise the widest part of the chain. In this regard, the cutter links generally include a top plate that extends out of the plane in which the side links generally lie to both sides. Accordingly, the top plate extends out beyond the transverse width of the side links 210 to ensure that the rivets 230 don't get bound within the cutting path formed during the cutting operations.

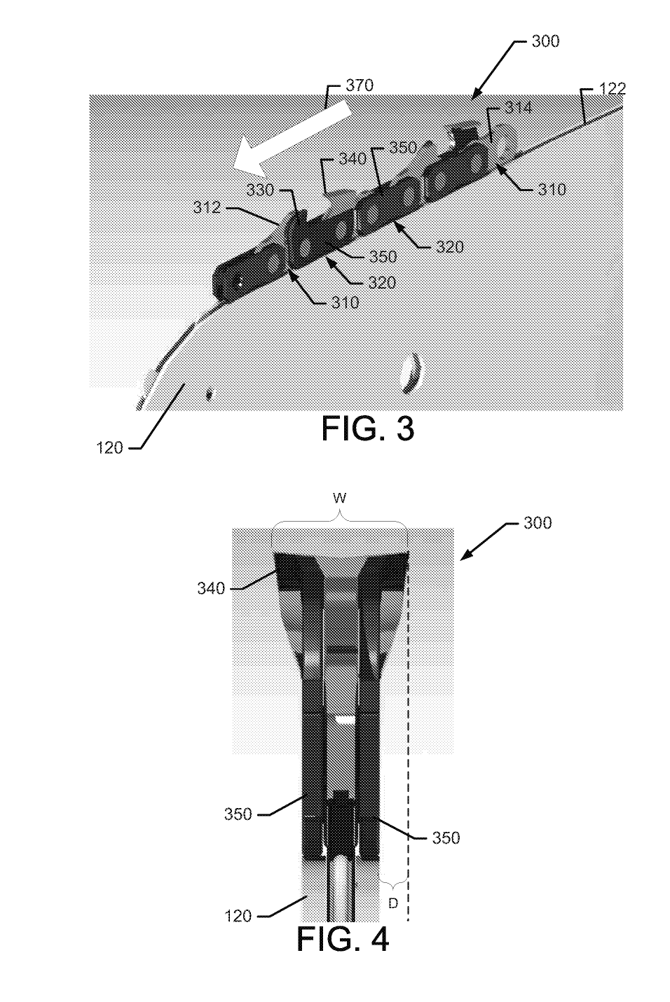

Given that the rivets 230 extend outside the width of the side links 210 (i.e., in the transverse direction as measured between corresponding outside faces of a pair of the side links 210 in a transverse direction), the amount of protrusion of the rivets 230 determines a minimum amount of overhang that the top plate must have. Accordingly, if the protrusion of the rivets 230 could be avoided, the amount of overhang of the top plate, and correspondingly the overall width of the chain, can be reduced. In order to provide a thinner chain, and perhaps a cut that is more like a cut made by a blade, example embodiments may provide for an improved chain with less width in the transverse direction. This may allow for a smoother, thinner and cleaner cut. FIGS. 3-5 illustrate an example of such an improved chain.

As shown in FIGS. 3-5, and particularly in FIG. 4, which shows a front view, the chain 300 of an example embodiment may have a relatively thin profile along the transverse direction. In this regard, because there are no rivets visible in the front view (owing to the fact that the rivets do not extend beyond base portions of the side links), an overhang distance (D) may be kept relatively small, and generally much smaller than the overhang distance on conventional chains. Although the transverse width (W) of the chain must still be greater than the bar (e.g., to prevent the bar from being bound in the cutting path, the transverse width (W) of a chain according to examples embodiments can nevertheless be reduced by decreasing the overhang distance (D). Accordingly, the transverse width (W) of the chain is also less than conventional chain widths.

FIG. 3 illustrates a portion of the chain 300, which should otherwise be understood to be continuous in its extension around the guide bar 120. FIG. 3 also illustrates the channel 122 of the guide bar 120 to illustrate how drive links 310 ride within the channel 122. Some of the drive links 310 may have bumpers 312 extending away from a base portion 314 thereof. The bumpers 312 of the drive links 310 may be disposed at a rear portion of each respective one of the drive links 310 on which the bumpers 312 are provided. Meanwhile, some of the side links 320 may include a depth gauge portion 330 and a cutting portion 340 to form cutter links. The depth gauge portion 330 and the side plate of the cutting portion 340 may extend away from base portions 350 of the corresponding side links 320 on the same lateral side of each respective side link 320 on which they are paired. The base portions 350 of the side links 320 and the base portions 314 of the drive links 310 may each lie in planes that are parallel to each other. The base portions 350 of the side links 320 and the base portions 314 of the drive links 310 may also be adjacent to each other in the following order: right base portion of side link, base portion of drive link, left base portion of side link. The side links 320 and drive links 310 may be operably coupled to each other via rivets 360 that pass through rivet holes 365 provided therein. Thus, the side links 320 and drive links 310 may fit together fairly closely.

As can be appreciated from FIGS. 3-5, the rivets 360 do not extend out of the lateral sides of the base portions 350. Moreover, according to an example embodiment, the rivets 360 may be flush with the lateral sides of the base portions 350. In other words, the lateral sides of the base portions 350 and the end faces of the rivets 360 may lie in the same plane. In some embodiments, the rivets 360 may be countersunk into the lateral sides of the base portions 350 to ensure that the rivets 360 do not extend beyond the lateral sides of the base portions 350. In examples in which it is not desired to place the lateral sides of the base portions 350 and the end faces of the rivets 360 may lie in the same plane, the rivet heads may in any case have reduced size to permit reduction in the overhang distance (D), and correspondingly also a reduction in the transverse width (W) relative to conventional chains.

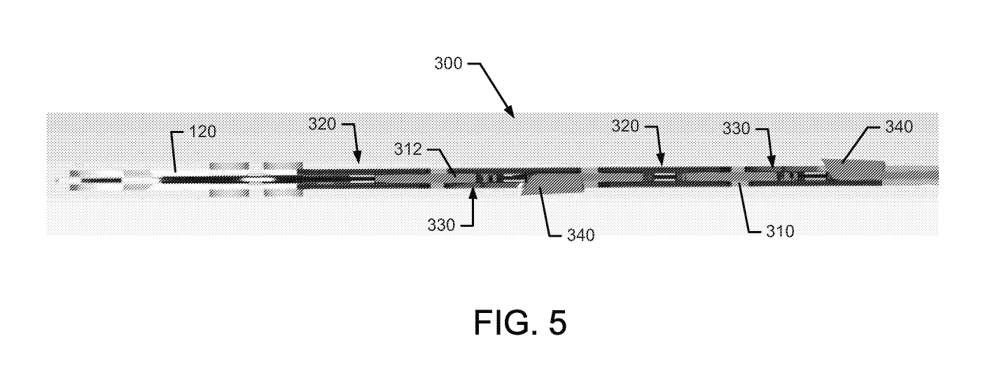

As shown in FIGS. 3 and 5, the bumpers 312 may be provided at rear portions of the drive links 310 and may be slanted away from the direction of chain motion (shown by arrow 370). Meanwhile, the depth gauge portions 330 of the side links 320 may be provided generally at a front end of the corresponding side links 320. Moreover, the depth gauge portions 330 of the side links 320 and the bumpers 312 of the drive links 310 may be placed substantially side by side with each other (when traversing straight portions of the guide bar 120). The depth gauge portions 330 of the side links 320 and the bumpers 312 of the drive links 310 may allow these elements to mutually reinforce each other to maintain the entire chain less susceptible to sideways drift.

As shown in FIGS. 3 and 5, the bumpers 312 may cooperate with the depth gauge portions 330 to limit the exposure of the cutting portion 340. As such, a bumpers 312 and depth gauge portions 330 precede each subsequent cutting portion 340. Moreover, groups of individual bumpers 312, depth gauge portions 330 and cutting portions 340 are provided on the same side within each group, but subsequent groups are provided on the opposite side of the chain 300. The combination of a thin and reinforcing structure with alternating cutting portions may create a smoother run. The smoother run also allows the chain 300 to cut more like a blade.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A cutting chain for a chainsaw, the cutting chain comprising:
a plurality of drive links arranged to lie in a plane parallel to a plane in which a guide bar about which the cutting chain is rotatable lies; and
a plurality of side links operably coupled to respective ones of the drive links and oriented to lie in respective planes substantially parallel to the plane, at least some of the side links comprising cutting portions,
wherein the drive links and side links are attached to each other by rivets, and the rivets have a longitudinal length that is less than or equal to a width defined between corresponding outside faces of a pair of the side links in a transverse direction.

2. The cutting chain of claim 1, wherein the rivets are countersunk into lateral sides of the side links.

3. The cutting chain of claim 1, wherein end faces of the rivets lie in a same plane as lateral sides of the side links.

4. The cutting chain of claim 1, wherein each cutting portion is preceded by a corresponding depth gauge portion provided on a same side link.

5. The cutting chain of claim 4, wherein each corresponding depth gauge portion is arranged proximate to a bumper disposed at a portion of an adjacent drive link.

6. The cutting chain of claim 5, wherein depth gauge portion and the bumper are side by side to at least partially overlap with each other.

7. The cutting chain of claim 1, wherein the cutting portion of at least some side links extends beyond the lateral sides of the side links.

8. The cutting chain of claim 1, wherein the rivets do not extend beyond the lateral sides of the side links.
